(19) United States
(12) Patent Application Publication
(10) Pub. No.: US 2026/0176063 A1
(43) Pub. Date: Jun. 25, 2026

(54) STORAGE AND RETRIEVAL FACILITY AND METHOD OF IMPLEMENTATION

(71) Applicant: EXOTEC PRODUCT FRANCE, CROIX (FR)

(72) Inventors: Romain MOULIN, Lille (FR); Renaud HEITZ, Villeneuve d’Ascq (FR)

(73) Assignee: EXOTEC PRODUCT FRANCE, CROIX (FR)

(21) Appl. No.: 19/051,426

(22) Filed: Feb. 12, 2025

(30) Foreign Application Priority Data
Dec. 20, 2024 (FR) FR2414822

(51) Int. Cl. B65G 1/04

(52) U.S. Cl. CPC B65G 1/0471; B65G 1/0435; B65G 1/0492

(57) ABSTRACT

A storage and retrieval facility for storage units including a plurality of storage racks, spaced apart from each other to form aisles, at least one transit location, arranged under at least one of the storage racks, at least one first vehicle, configured to circulate in the aisles and to transport a storage unit between a storage location located at a height and the at least one transit location, at least one second vehicle configured to transport a storage unit between the at least one transit location and at least one location external to the storage racks, at least one free passage, adjacent to the transit location and configured to allow the at least one second vehicle to travel along a traffic lane that is transverse to the aisles.

The present disclosure relates to a storage and retrieval facility for storage units, as well as to a method for storage and retrieval that is implemented by said facility.

The present disclosure finds a particular application when the storage units comprise a pallet intended to receive palletized contents. The contents may comprise objects, namely items or packaging such as cartons which are grouped on the pallet. The objects are typically retained on the pallet by means of stretch film. The stretch film is unrolled around the contents while kept taut, typically along the entire height of the contents, so that it holds all of the objects on the pallet, trapped in an envelope formed by the stretch film wrapped around the contents.

In general, the pallets may be in the 1200×1000 format (length and width in millimeters), for example an ISO pallet, or any other format known to those skilled in the art such as 1200 by 800 for a pallet in European format.

In such a case, the storage and retrieval facility will automate the storage and retrieval of pallets, and more generally of palletized contents which typically can have a load of more than 100 kg, for example between 100 kg and 1000 kg, or even more.

The present disclosure is not limited to the field of pallets, however, and may find particular applications in the storage and retrieval of containers, typically standard containers suitable for implementing order preparation at one or more order preparation stations of said facility.

### TECHNICAL FIELD

The present disclosure relates to the field of automated storage and retrieval systems, typically comprising storage racks in which palletized contents can be stored and retrieved.

### BACKGROUND

Known from a first state of the art are stacker cranes, which move along the length of the aisles between the storage racks. These stacker cranes represent a cumbersome solution requiring the installation of stacker crane guide rails on the ceiling and floor, for guiding a mast. This is a difficult and expensive solution to implement, and is of limited capacity.

One improvement to such a state of the art is described in document WO2023/159401. The automated storage and retrieval system comprises two types of vehicles:
a first vehicle similar to a stacker crane, guided in an aisle between two storage racks by rails arranged at the top and bottom of the two racks. This first vehicle is configured to transfer palletized content between a high location in a rack and a second vehicle parked outside the aisle, and
a second automated guided vehicle that moves outside the aisle, configured to transport the palletized content received from the first vehicle.

The first vehicle comprises in particular two masts and a fork that can be moved vertically up and down between the masts, the fork further being configured to transfer palletized content between the first vehicle and one of the storage locations. The second vehicle comprises grooves in particular, which are configured to receive the fork of the first vehicle, thus enabling the transfer of the palletized content between the first vehicle and the second vehicle.

Similarly to conventional stacker cranes, this solution remains expensive and difficult to implement.

Known from a second state of the art, illustrated for example by document US 2016/0090283 A1, are automated guided vehicles which comprise a system for horizontal movement and a transfer system, typically a telescopic fork, that is movable up and down in order to bring it in alignment with a storage location.

Such vehicles move about in the aisles, and are configured to transfer a load such as palletized content, between a storage location in the rack and the vehicle.

Such a vehicle may be used to retrieve palletized content, then it is moved along the aisle to convey the content to a desired location external to the storage racks. Such a solution, using a same type of vehicle, is slow for the following reasons:
such vehicles typically move among people, which requires limiting their speed of movement according to the safety standards typically in force,
it takes time to move the vehicle along the aisle until the vehicle exits the racks,
additional time is required after the vehicle exits if the vehicle is to deposit the palletized contents on a depositing device, at a distance from the storage racks.

A third solution for the facility comprises shuttles respectively circulating at several different height levels along the aisles between two storage racks, each shuttle guided by horizontal rails integral to the two storage racks, and enabling the extraction of a storage unit from a storage and transport location at the end of the aisle for transfer to a lowering device, ensuring the vertical routing of the storage unit to one or more conveyors.

Document US 2017/0101264 illustrates a variant of such a state of the art facility. In that document, the facility comprises, at each height level, rows arranged transversely to the aisles. Aisle shuttles move the palletized contents along the aisles to and from elevators, and row shuttles move the palletized contents from the aisle shuttles and along the rows. However, this is an expensive solution, and not suitable for reaching high processing capacities.

More recently, known in a fourth state of the art disclosed by document WO2024/091954 A1, is an automated storage and retrieval system designed for navigation by an automated guided vehicle in a three-dimensional environment. The system comprises a multi-level storage facility with cuboid cells and an automated guided vehicle capable of supporting palletized contents and of moving vertically and horizontally.

Such a solution requires specific storage facilities carrying climbing elements, which increases their cost. Another disadvantage of such a solution is the impossibility of using high-power motors, which requires limiting the speed of vertical movement, especially when the load becomes significant, as is encountered with palletized contents.

According to the inventors' findings, such a state of the art solution can be improved, in particular concerning the management of logistics flows and the capacities of the facility.

### SUMMARY

The present disclosure improves the situation.

According to a first aspect, a storage and retrieval facility for storage units is provided, comprising:
/a/ a plurality of storage racks, spaced apart from each other to form aisles, each storage rack comprising a plurality of superimposed storage locations for supporting storage units at a height relative to a horizontal surface such as the floor,
/b/ at least one transit location (in particular one or more transit locations), arranged under at least one of the storage racks, for temporarily receiving a storage unit,
/c/ at least one first vehicle configured to circulate in the aisles and to transport a storage unit between a storage location located at a height and said at least one transit location,
/d/ at least one second vehicle configured to transport a storage unit between said at least one transit location and at least one location external to the storage racks,
/e/ at least one free passage under said storage racks, adjacent to said transit location, configured to allow said at least one second vehicle to travel along a traffic lane that is transverse to the aisles.

The transit locations and the free passages may be arranged to alternate along the length of the storage rack so that at least one free passage is adjacent and laterally associated with each transit location.

The features set forth in the following paragraphs may optionally be implemented for the facility according to the first aspect, independently of each other or in combination with each other:
According to one possibility, the first vehicle is configured to transport said storage unit between said storage location located at a height, to resting on an upper surface of at least one second vehicle parked at the transit location;
According to another possibility, said transit location may comprise a mechanical storage system configured for temporarily supporting a storage unit at a distance from the horizontal surface, and a longitudinal movement of the second vehicle from the free passage to said adjacent transit location ensures that the second vehicle is in an insertion position under said storage unit supported by the mechanical storage system;
In particular, said mechanical storage system may comprise a pair of mechanical interfaces comprising a first mechanical interface and a second mechanical interface, which are parallel to each other, each oriented longitudinally along the length of the storage rack, and said second vehicle is arranged between the first interface and the second interface in the insertion position.

According to one embodiment, the second vehicle may comprise a lifting system comprising a platform configured to move from a low position which allows positioning the second vehicle below a storage unit resting on the mechanical storage system, to a high position where the platform raises the storage unit and disengages said storage unit from the mechanical storage system.

According to one embodiment, said facility may comprise storage units which each have a width dimension, and a length dimension that is greater than the width dimension, and:
the storage units are stored in the storage locations longitudinally, along a depth dimension of the storage rack that is transverse to the storage rack, and
the first vehicle is configured to transport one of the storage units from a storage location located at a height to a transit location, without changing the orientation of said storage unit, by positioning said storage unit on the transit location, oriented longitudinally along the transverse direction of the storage rack.

According to one embodiment, the or each storage rack may comprise several columns distributed along the lengthwise direction of the storage rack, each column comprising a plurality of superimposed storage locations for respectively receiving a plurality of storage units, and the second vehicle or vehicles comprise a length dimension that is less than or equal to the depth dimension of the storage rack, and a width dimension that is less than the length of the second vehicle, less than the longitudinal dimension of a storage location.

According to one embodiment, the first mechanical interface and the second mechanical interface may be spaced apart, in the direction transverse to the storage rack, by a distance that is greater than the length dimension of a second vehicle.

According to one embodiment, all or part of the free passages are dual passages which are adjacent to a same transit location, the dual passages enabling two second vehicles, each possibly carrying a storage unit, to travel along a respective first traffic lane and second traffic lane which are independent, in opposite directions and transverse to the storage rack, the two second vehicles being able to pass by each other through the free passages adjacent to a same transit location.

According to one advantageous embodiment, the second vehicle may be configured to transport a storage unit between said at least one transit location and said at least one location external to the storage racks, by implementing:
at least one transverse movement of the second vehicle along the traffic lane, followed or preceded by
a longitudinal movement of the second vehicle between the free passage and said at least one adjacent transit location, below one of the storage racks, in a movement direction that is longitudinal to said storage rack.

A change of direction is made between the longitudinal movement and the transverse movement, which may be made without a change of orientation of a body of the second vehicle according to one possibility, or is made with a change of orientation of the body according to another possibility.

According to one embodiment, the or each second vehicle may comprise a horizontal drive system configured to ensure movement on the horizontal surface and to move the second vehicle selectively in a first direction parallel to the longitudinal direction of the storage racks, or in a direction transverse to the longitudinal direction of the rack, as well as a system for changing direction from the first direction to the second direction or vice versa, without changing the orientation of the vehicle.

According to one embodiment, the first vehicle(s) comprise, in whole or in part:
a horizontal drive system configured to move the vehicle on the horizontal surface,
at least one mast, and
a transfer system which is movable vertically along the mast, configured to transfer a storage unit between the first vehicle and one of the storage locations.

According to one embodiment, said facility may comprise storage units, and the storage units are palletized contents, each comprising a pallet.

According to one embodiment, said facility may comprise a peripheral barrier forming an enclosure with limited access, containing the storage racks as well as the first vehicles and second vehicles circulating on the horizontal surface.

According to one embodiment, said facility may comprise:
an input conveyor for storage units, crossing the peripheral barrier in order to bring storage units to at least one location external to the storage rack, said units being intended to be transported by the second vehicles to at least one transit location, for the purposes of loading them into storage locations in the rack,
an output conveyor for storage units, crossing the peripheral barrier in order to bring out storage units that have been retrieved from storage locations in the storage rack and conveyed by the second vehicles from at least one transit location to at least one location external to the storage racks.

According to a second aspect, the present disclosure relates to a method for loading and retrieval which makes use of a storage and retrieval facility according to the present disclosure, wherein:
a retrieval of a storage unit from a storage location in one of the storage racks is carried out by:
   automated transfer operations which transfer the storage unit from the storage location in the storage rack to at least one transit location under the storage rack, via the or one of the first vehicles, then by:
   automated transfer operations which transfer the storage unit via the or one of the second vehicles from said at least one transit location to at least one location external to the storage racks, and/or
a loading of a storage unit into a storage location in the storage rack is carried out by:
   automated transfer operations which transfer the storage unit from said at least one location external to the storage racks to at least one transit location under one of the storage racks, via the or one of the second vehicles, then by,
   automated transfer operations which transfer the storage unit from said at least one transit location to the storage location in said storage rack, via the or one of the first vehicles.

According to one embodiment of the method which makes use of a facility according to the present disclosure, in particular one without a mechanical storage system:
during a retrieval according to the second aspect, said at least one first vehicle transfers the storage unit from the storage location in the storage rack to at least one transit location under the storage rack, by depositing the storage unit on the second vehicle parked at said at least one transit location;
during a loading according to the second aspect, said at least one second vehicle carrying the storage unit is parked at said at least one transit location, when said at least one first vehicle transfers the storage unit from said transit location to the storage location.

According to another embodiment of the method for loading and retrieval according to the present disclosure and making use of a facility according to the present disclosure, provided with at least one mechanical storage system:
during a retrieval according to the second aspect, said at least one first vehicle transfers the storage unit from the storage location in the storage rack to at least one transit location under the storage rack, by depositing the storage unit on the mechanical storage system, at a distance from the horizontal surface,
during a loading according to the second aspect, the storage unit has been stored at the transit location at a distance from the horizontal surface via the mechanical storage system, when said at least one first vehicle transfers the storage unit from said transit location.

According to one embodiment of the method for loading and retrieval of the present disclosure, making use of a facility according to the present disclosure:
during a retrieval according to the second aspect, the automated transfer operations via the or one of the second vehicles are carried out by the or one of the second vehicles traveling at least in said longitudinal movement from said at least one transit location to the adjacent free passage, followed, after a change in direction of the second vehicle, by a transverse movement of the second vehicle through the free passage along the traffic lane, in order to exit the storage racks to at least one location external to the storage racks,
during a loading according to the second aspect, the automated transfer operations via the or one of the second vehicles are carried out by the or one of the second vehicles traveling along the traffic lane to the free passage below the storage rack and adjacent to said at least one transit location, followed, after a change in direction of the second vehicle, by longitudinal movement from the free passage to said adjacent transit location.

According to one embodiment, the presence of the dual free passages can make it possible to implement a method for loading and retrieval in which the free passages adjacent to said transit location are dual passages, comprising for the or for each transit location:
first free passages of different storage racks, forming the first traffic lane for the second vehicles,
second free passages of said different storage racks, forming the second traffic lane for the second vehicles.

Advantageously, the method may provide that the second vehicles travel only in a first direction along the first traffic lane, and the second vehicles travel only in a second direction, opposite to the first direction, along the second traffic lane. As the lanes are independent, the traveling of the second vehicles along the first traffic lane does not interfere with the traveling of the second vehicles along the second traffic lane.

The present disclosure further relates to a facility according to the present disclosure comprising a control unit, in particular a central processing unit, comprising one or more microprocessors, a memory, and a set of instructions configured for co-operating with the microprocessor(s) in order to implement the method for loading and retrieval according to the present disclosure.

### BRIEF DESCRIPTION OF DRAWINGS

Other features, details and advantages will become apparent upon reading the detailed description below, and upon analysis of the attached drawings, in which:

FIG. 1 illustrates an embodiment of a storage and retrieval facility that comprises:
storage racks, arranged parallel to each other, forming aisles between the racks, each rack comprising a plurality of columns distributed along the length of the rack, each column comprising a plurality of superimposed storage locations for storing the storage units,
first vehicles comprising a transfer system that can be moved vertically along a mast, the first vehicles being configured to serve the storage locations in the storage rack,
temporary storage systems arranged under the racks, formed by pairs of mechanical interfaces, certain locations under the rack being without any mechanical interfaces in order to leave free passages for the circulation of vehicles through the storage racks,
second vehicles configured to move under the storage racks in order to deposit or pick up storage units under the racks, and configured to move transversely to the storage rack through the free passages,
a peripheral barrier forming an enclosure for the storage racks as well as an enclosure for the first vehicles and the second vehicles, which limits access,
an input conveyor configured to bring storage units into said enclosure,
an output conveyor configured to bring storage units out of said enclosure.

FIG. 2 is a top view of the facility, illustrating:
the traffic lanes for the first vehicles, along the aisles between the storage racks,
the traffic lanes for the second vehicles, transverse to the storage rack, enabling circulation across dual free passages transverse to the storage rack, comprising a first traffic lane for second vehicles to travel in a first direction only, and a second, independent traffic lane for second vehicles to travel in a second direction only that is opposite to the first direction.

FIG. 2A is a detailed view of an alternative of FIG. 2, in which the first traffic lane and second traffic lane, transverse to the storage rack, are arranged one on either side of the pairs of adjacent mechanical interfaces, FIG. 2A illustrating a possible path of the second vehicle, which:
moves along the first traffic lane in the first direction to one of the free passages under the storage rack, adjacent to the pair of mechanical interfaces,
changes direction and moves longitudinally to the storage rack into a position between the mechanical interfaces of the pair of mechanical interfaces, in order to pick up a storage unit by raising the platform, or in order place a storage unit on the two mechanical interfaces of the pair, when the second vehicle is stopped between the mechanical interfaces,
moves longitudinally to another free passage on the second independent traffic lane,
changes direction and moves transversely to the storage rack along the second traffic lane, in a second direction that is opposite to the first direction.

FIG. 3 is a detailed view of FIG. 2, illustrating the path of a second vehicle along a transverse direction to the free passage, then, after a change of direction of the second vehicle, along a longitudinal direction to a position of the second vehicle between the two mechanical interfaces of the pair which are supporting a storage unit, and in particular palletized content, notably illustrating the length dimension of the second vehicle, which is oriented in the transverse direction and which is less than the spacing between the two mechanical interfaces of the pair.

FIG. 4 is a detailed view illustrating the circulation of the second vehicles, which are configured to circulate from the mechanical storage systems and along a path in order to deposit a storage unit at a location external to the rack, such as on a first transfer device associated with the output conveyor, and then to load themselves with a storage unit coming from the input conveyor via a second transfer device.

FIG. 5 is a view of the first vehicle, which is in a transverse avenue between racks, and is configured to travel along said avenue in order to change from an aisle between two racks to another aisle between two other different racks.

FIG. 6 is a view of the first vehicle between two storage racks.

FIG. 7 is a schematic view of one embodiment of a cart having a horizontal drive system that comprises a plurality of motorized wheels.

FIG. 7A is a view of one possible embodiment of a system for changing the direction of the cart of FIG. 7.

FIG. 8, FIG. 9 and FIG. 10 are views of one possible embodiment of a transfer system of first vehicles, respectively in a retracted position, in a first deployed position, and in a second deployed position.

### DETAILED DESCRIPTION

The present disclosure thus relates, according to a first aspect, to a storage and retrieval facility 1 for storage units U, comprising:
/a/ a plurality of storage racks 2, spaced apart from each other to form aisles 3, each storage rack 2 comprising a plurality of superimposed storage locations for supporting storage units U at a height relative to a horizontal surface SH such as the floor,
/b/ at least one transit location ET arranged under at least one of storage racks 2, for temporarily receiving a storage unit U,
/c/ at least one first vehicle V1 configured to circulate in aisles 3, said first vehicle further being configured to transport a storage unit U between a storage location located at a height and said at least one transit location ET,
/d/ at least one second vehicle V2 configured to transport a storage unit U between said at least one transit location ET and at least one location EE external to the storage racks.

In general and according to an XYZ reference system in FIG. 1:
the X direction, horizontal and transverse, can represent the width (or depth) direction of the storage racks 2,
the Y direction, horizontal and longitudinal, can represent the length direction of the storage racks 2,
the Z direction, vertical, can represent the vertical direction of the storage racks.

The storage racks may have uprights 20, extending in vertical direction Z, which are distributed in length direction Y of the rack and in width direction X. Longitudinal crosspieces 21 may connect successive uprights, in longitudinal direction Y, and transverse crosspieces may connect the uprights in transverse direction X.

The longitudinal crosspieces may be distributed at different height levels along vertical direction Z, in order to form different superimposed support surfaces for storing storage units U. Alternatively, the storage units may rest on mechanical interfaces, typically brackets, projecting towards each other along direction Y and according to an embodiment not illustrated.

For example, the or each of the storage units U may rest on two longitudinal crosspieces at a same level which are parallel to each other, and in particular when the storage unit comprises a pallet.

The spacing between uprights 20, along longitudinal direction Y, is typically constant and typically greater than at least the dimension of storage unit U when it is stored in one of the storage locations of the rack. The spacing between two successive uprights 20 along the length of the rack may correspond to the dimension of the storage unit, or may even be slightly greater than this dimension, in order to store a single storage unit in a storage location, along this direction between the two uprights.

The spacing between two successive uprights 20 along the length of the rack may correspond to a multiple (for example a multiple of 2, of 3, of 4, etc.) of the dimension (in particular the width) of the stored storage unit but slightly greater than this dimension, in order to form several adjacent storage locations (for example 2, 3, 4, etc.) configured to store a plurality of storage units, one next to the other, along this direction between the two uprights. The different storage locations, adjacent along the longitudinal direction, may or may not be physically delimited.

For example, in FIG. 1, two successive uprights of the storage rack are spaced apart by a dimension that is slightly greater than three storage units, so as to allow storing three storage units U side by side between the two uprights, at three storage locations located next to each other between the two uprights.

Generally speaking, the spacing between two successive uprights allows loading or unloading the storage unit, in transverse direction X, by inserting or removing the storage unit in the transverse direction.

The spacing between two successive uprights, in transverse direction X, may correspond to the dimension of storage unit U (for example the length dimension) stored in a storage location between the two successive uprights.

Generally, the storage rack (or each storage rack) forms a plurality of columns along the length of the rack, namely along longitudinal direction Y, each column comprising a plurality of superimposed storage locations respectively configured to receive storage units, namely each storage location is configured to receive a storage unit U. In one embodiment (not illustrated), each column is in particular restricted along longitudinal direction Y, by uprights 20 of the rack.

According to one embodiment, and in FIGS. 1, 2, each storage rack allows storing, for each level of the rack, an integer number N_{U} of storage units which is a multiple of three, and thus comprises N_{U} columns, in the longitudinal direction Y. For example, in FIG. 1, three columns which are side by side in the longitudinal direction are interposed between two successive uprights 20 of the rack. For example, the number N_{U} is equal to 12 and the number of columns is equal to 12.

Generally, storage racks 2 rest on horizontal surface SH, typically by means of their uprights 20. Horizontal surface SH may typically be a surface for circulating such as the floor of the facility.

The storage locations in the storage racks are intended for storing storage units. The storage racks may comprise several storage racks 2 arranged in parallel, separated by one or more aisles each extending lengthwise in longitudinal direction Y, in particular:
several (first) storage racks 2 arranged in parallel, separated by one or more first aisles Al1
several (second) storage racks 2 arranged in parallel, separated by one or more second aisles Al2.

Generally, the storage locations of two of the storage racks arranged one on either side of one of the aisles are served (loaded or unloaded) by a first vehicle V1.

In one embodiment (not shown), storage locations are provided under the storage racks, in addition to transit locations ET. Allowing for storage units underneath the storage racks makes it possible to increase the storage density.

Transit location(s) ET are arranged under storage racks 2 and are configured for temporarily receiving a storage unit U.

According to one possibility, in particular as illustrated in the figures, transit locations ET may have mechanical storage systems SMT, as illustrated in the figures. The (or each) mechanical storage system allows temporarily storing a storage unit U, at a vertical distance from horizontal surface SH.

Such a mechanical storage system makes it possible to decouple the operations of first vehicle V1 and second vehicle V2 during retrieval or loading operations.

During retrieval operations, first vehicle V1 may transfer a storage unit from one of the storage locations, until it is deposited on mechanical storage system SMT, without waiting for one of the second vehicles. The mechanical storage system thus ensures a temporary storing of storage unit U, while one of the second vehicles slides under storage unit U in order to ensure transport of the storage unit to outside the storage racks.

Conversely, during loading operations, one of second vehicles V2 may travel to mechanical storage system SMT and deposit said storage unit thereon, without waiting for first vehicle V1. The mechanical storage system thus temporarily stores storage unit U, until first vehicle V1 comes to pick up storage unit U and transfer it to one of the storage locations in the storage rack.

The first storage racks and the second storage racks may be juxtaposed, separated by an avenue Av. Avenue Av is delimited by the first racks on one side, and by the second racks on a second side. Avenue Av extends in transverse direction X and may be in communication with first aisles Al1 and second aisles Al2. One will note that the first storage racks and the second storage racks may respectively extend significantly in the longitudinal direction.

According to a second possibility (not illustrated), transit location ET may be without any mechanical storage system under the rack and intended to provide support for the storage unit plus its temporary storage, at a vertical distance from horizontal surface SH. Such a solution requires synchronizing the operations of first vehicle V1 and second vehicle V2 during retrieval or loading operations. First vehicle V1 is then configured to transport said storage unit between said storage location located at a height until it rests on an upper surface of at least one second vehicle V2 parked at transit location ET.

In other words, according to this second possibility, transit location ET is a dedicated area under the rack for parking a second vehicle waiting to receive a storage unit.

During retrieval operations, first vehicle V1 may transfer a storage unit from one of the storage locations until it is deposited on one of second vehicles V2 parked in transit location ET. A second vehicle V2 must therefore first be moved to transit location ET, before first vehicle V1 deposits said storage unit.

Conversely, during loading operations, one of the second vehicles moves to transit location ET while carrying a storage unit U, and, successively, first vehicle V1 ensures the transfer of the storage unit loaded on the second vehicle parked at said transit location, to one of the storage locations in storage rack2.

Generally, transit location ET, or all or part of the transit locations, are arranged vertically in line with a storage location in a column of the storage rack.

Storage racks 2 may comprise a plurality of pairs of vertical uprights, each pair of uprights comprising a proximal upright, close to the aisle, facing a distal upright, further from the aisle. Transit location ET (including, where applicable, mechanical storage system SMT) may have a footprint in the transverse direction of the storage rack that is less than or equal to the distance between one of the proximal uprights and one of the distal uprights of the storage rack, namely substantially equal to the width dimension of the storage rack in transverse direction Y.

Transit location ET (including, where applicable, mechanical storage system SMT) may have a dimension in the longitudinal direction of storage rack 2 that is greater than or even equal to the dimension of a storage unit when temporarily stored in the transit location.

Transit location ET (with mechanical storage system SMT or without such a mechanical storage system) may occupy space on horizontal surface SH, such as the floor, that is within the limits of one of the columns, and more particularly of a storage location in the column.

According to one embodiment, all or part of transit locations ET may extend individually within the limits of the column, more particularly within the limits of a storage location in the column, in line with the column, meaning the transit location is vertically aligned with individual superimposed storage locations of the column. It is then possible to transfer a storage unit U between a storage location and said transit location at right angles to the column, by a movement comprising a component in vertical direction Z and a component in transverse direction X only, meaning that the movement of the storage unit is without any component in longitudinal direction Z.

Said at least one first vehicle V1 is configured to circulate in aisles 3, and is configured to transport a storage unit U between a storage location located at a height in a storage rack, and said at least one transit location ET.

Also, first vehicle V1 mainly travels in longitudinal direction Y, along aisles 3. Said first vehicle may also travel in transverse direction X on avenue Av, as illustrated in FIG. 2, and again in direction Y in order to change from one aisle to another, for example to go from a first aisle Al1 to another first aisle, from a first aisle to a second aisle Al2, or vice versa, or even to go from a second aisle Al2 to another second aisle.

First vehicle(s) V1 may have a horizontal drive system configured to move the vehicle on the horizontal surface. The horizontal drive system is configured to move the first vehicle selectively in a first direction parallel to the longitudinal direction of the storage racks along the aisles, or in a direction transverse to the longitudinal direction of the rack, in particular along the avenue, such a horizontal drive system having one or more motorized wheels.

First vehicle V1 is preferably configured to circulate freely on horizontal surface SH. In other words, the horizontal surface is without any guide rails, in particular for guiding the movement of the first vehicle.

According to one embodiment, the horizontal drive system may have a system for changing direction from the first direction to the second direction or vice versa, without changing the orientation of the vehicle which always remains oriented longitudinally, parallel to the longitudinal direction of the storage racks.

This may involve the solution described in application EP4373690, in which the cart comprises at least three drive wheels intended to roll on the ground, capable of pivoting at least 90°.

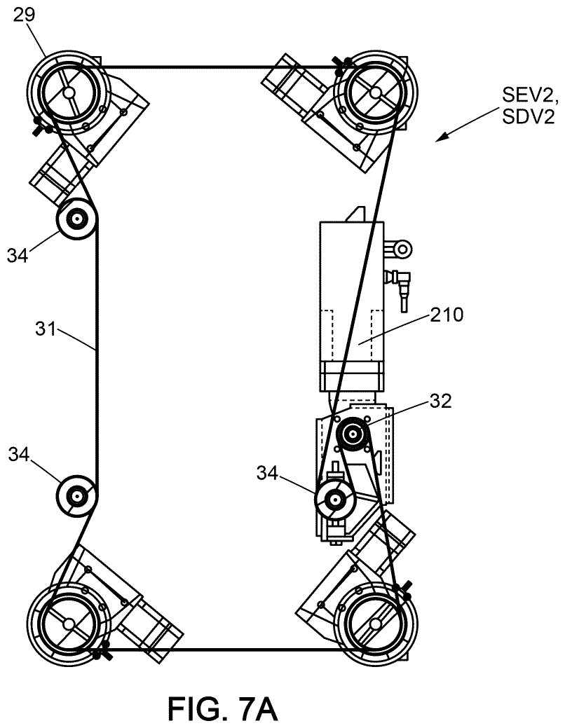

As illustrated by way of example in FIGS. 7 and 7A, said drive wheels 29 are mounted on pivoting and driving devices fixed to body 23 of said cart, each of said pivoting and driving devices comprising a motor for actuating the means for pivoting a drive wheel 29 about a vertical axis, intended to pivot a drive wheel 29 about itself.

The various drive wheels 29 can be pivoted about their vertical axis, preferably by a single motor 210 for rotating said drive wheels 29, intended to actuate means for rotating said drive wheels housed in said pivoting and driving devices. Motor 210 drives a toothed belt 31, via a roller 32 coupled to the drive shaft. Belt 31 is kept taut by means of tensioner rollers 34.

The system for changing direction may alternatively comprise omnidirectional wheels.

In yet other embodiments, the system for changing direction ensures the change of direction by changing the orientation of the body of the vehicle, for example by means of one or more pivoting wheels, or by controlling the motorized wheels at different rotation speeds.

First vehicle V1 may also typically comprise at least one mast Mt, and a transfer system ST which is vertically movable along the mast and configured to transfer a storage unit between the first vehicle and one of the storage locations.

Said at least one mast extends from a body of the first vehicle and may comprise a first mast Mt1 and a second mast Mt2, which are parallel. Transfer system ST is configured to move heightwise along the direction of said at least one mast. Said mast, in particular the first mast and second mast, may be telescopic and be retracted into a position of smaller vertical dimension, in particular when the first vehicle is moving, and may be deployed to reach the upper storage locations of the storage rack, for example storage locations arranged at up to 12 meters high.

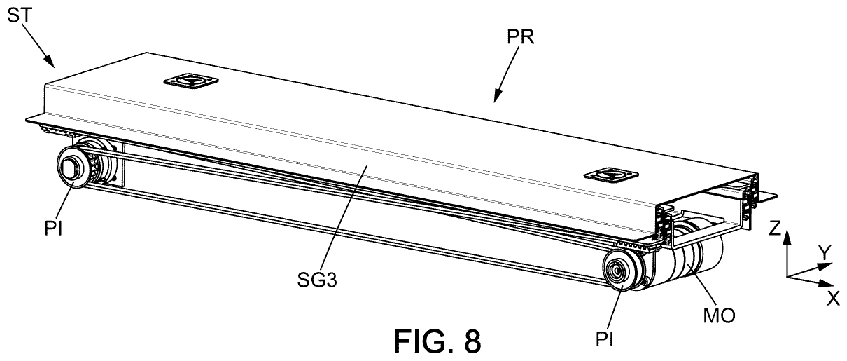

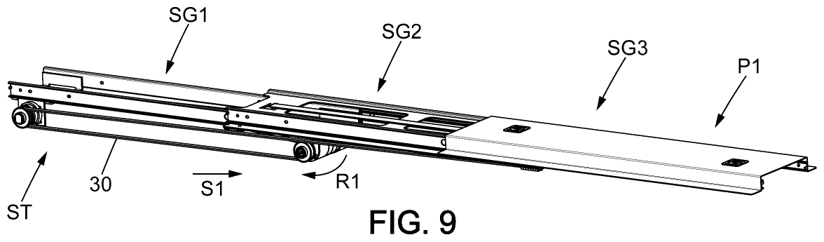

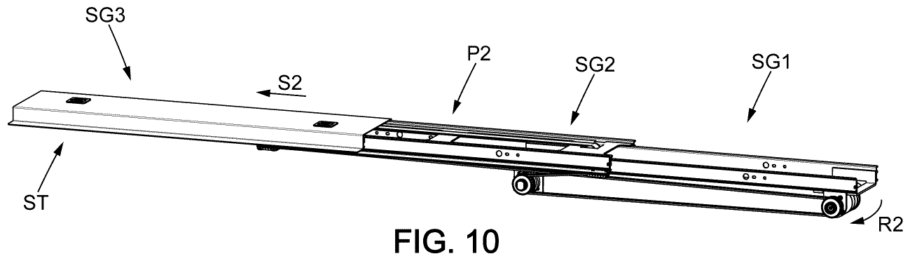

The transfer system may typically comprise a telescopic system, in particular as taught by document FR3148017A1, in particular as illustrated in FIGS. 8 to 10, or as taught in that document as prior art. Such a telescopic system ST may comprise a telescopic arm comprising a first segment SG1 and a second segment SG2 which is mounted to slide relative to the first segment in transverse direction X, in particular when first vehicle V1 is in one of aisles 3.

A motorized actuation device comprises a transmission connecting the first segment and the second segment, the transmission comprising a belt 30 and pulleys PI rotatably mounted on first segment SG1 cooperating with belt 30, as well as a motor MO configured to drive one of the motorized pulleys, said pulleys being arranged in at least two offset positions on the first segment along the sliding direction.

The motorized actuation device is configured to, in a first direction of rotation of the motorized pulley, deploy the telescopic system from a retracted position PR (FIG. 8) between first segment SG1 and second segment SG2 to a deployed position (FIG. 9 or 10) between the first segment and the second segment, and, in a second direction of rotation of the motorized pulley, to retract the transfer system from the deployed position to the retracted position.

In retracted position PR of the telescopic system, the transfer system can ensure the positioning of said storage unit in the aisle, for example directly above the body of the first vehicle, in particular between first mast Mt1 and second mast Mt2. The transition of the telescopic system into the deployed position makes it possible to move said storage unit in the transverse direction, into the rack, for the purposes of depositing it in a storage location.

According to one embodiment, the telescopic system may be:
deployable from retracted position PR to the deployed position which is a first deployed position P1 in a first deployment direction S1 of the second segment relative to the first segment and as illustrated in FIG. 9,
deployable from the retracted position to a second deployed position P2, in a second deployment direction S2 of the second segment relative to the first segment and as illustrated in FIG. 10.

From a position of first vehicle V1 in one of aisles 3 between two storage racks 2, the deployment of the telescopic system into first deployed position P1 allows transferring storage unit U into one of the two storage racks, and the deployment of the telescopic system into second deployed position P2 allows transferring the storage unit into the other storage rack which is opposite relative to said aisle.

The motorized actuation device is then configured to, in the first direction of rotation R1 of the motorized pulley, deploy the telescopic arm from the retracted position between the first segment and the second segment to the first deployed position between the first segment and the second segment, and, in the second direction of rotation of the motorized pulley, to retract the segment system from the first deployed position to the retracted position.

The motorized actuation device is further configured to, in the second direction of rotation R2 of the motorized pulley (opposite to the first direction R1), deploy the segment system from the retracted position between the first segment and the second segment to the second deployed position between the first segment and the second segment, and, in the first direction of rotation of the motorized pulley, to retract the segment system from the second deployed position to the retracted position PR.

In general, the telescopic arm may have a third segment SG3 which slides on the second segment in the sliding direction, as well as a second transmission comprising an opposing first belt and second belt:
said first belt having a first end linked to the first segment and a second end linked to the third segment, said first belt cooperating with a pulley integral to the second segment, said first belt configured to be tensioned and to ensure the deployment of third segment SG3 relative to second segment SG2 during deployment of second segment SG2 relative to first segment SG1 from the retracted position to the deployed position,
the second belt having a first end linked to the first segment and a second end linked to third segment SG3 cooperating with a pulley integral to second segment SG2, said second belt configured to be tensioned and to ensure the retraction of third segment SG3 relative to second segment SG2 during retraction of second segment SG2 relative to first segment SG1 from the deployed position to the retracted position.

The first vehicle may be a three-way self-guided forklift designed to work in narrow aisles. This forklift comprises a deployable fork system that can pivot in order to deposit or extract a storage unit from a storage rack, on either side of the aisle, without the forklift turning in the aisle.

The first vehicle may also be a self-guided forklift provided with a telescopic fork system with bilateral movement for depositing or extracting a storage unit on either side of the aisle in which it travels.

The or each second vehicle V2 may have a horizontal drive system SEV2 configured to ensure movement over the horizontal surface, said horizontal drive system SEV2 comprising one or more motorized wheels. Second vehicle V2 preferably moves freely over the horizontal surface. In other words, the horizontal surface is without any guide rails.

Horizontal drive system SEV2 is configured to move second vehicle V2 selectively, mainly in a direction transverse to the longitudinal direction of the rack, but also in a first direction parallel to the longitudinal direction of storage racks 2. Horizontal drive system SEV2 may have a system for changing direction SDV2 from the first direction to the second direction or vice versa, without changing the orientation of the vehicle which always remains oriented longitudinally, perpendicular to the longitudinal direction of storage racks 2.

This may involve the solution described in application EP4373690, described above in relation to FIGS. 7 and 7A.

The system for changing direction may alternatively comprise omnidirectional wheels.

In yet another embodiment, the system for changing direction provides the change in direction by changing the orientation of the vehicle body, for example by means of one or more pivoting wheels, or by controlling the motorized wheels at different rotation speeds.

The horizontal drive system of the second vehicles may be identical to or different from that of the first vehicles.

Generally, second vehicle(s) V2 are configured to travel outside the storage racks, across the aisles, or under storage racks 2, in order to transfer a storage unit U between a location external to the racks and transit location ET.

The second vehicle(s) may further be configured to travel in the aisles, in coordination with first vehicles V1.

Advantageously, the system for determining the position of the first and second vehicles, such as lines on the floor or location identifiers on the floor or on the rack, is shared by the first and second vehicles.

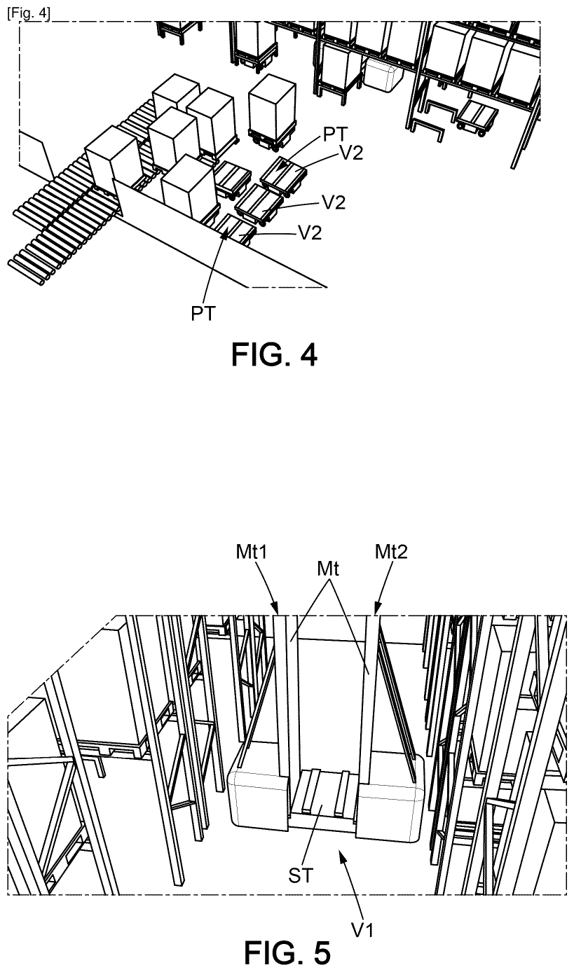

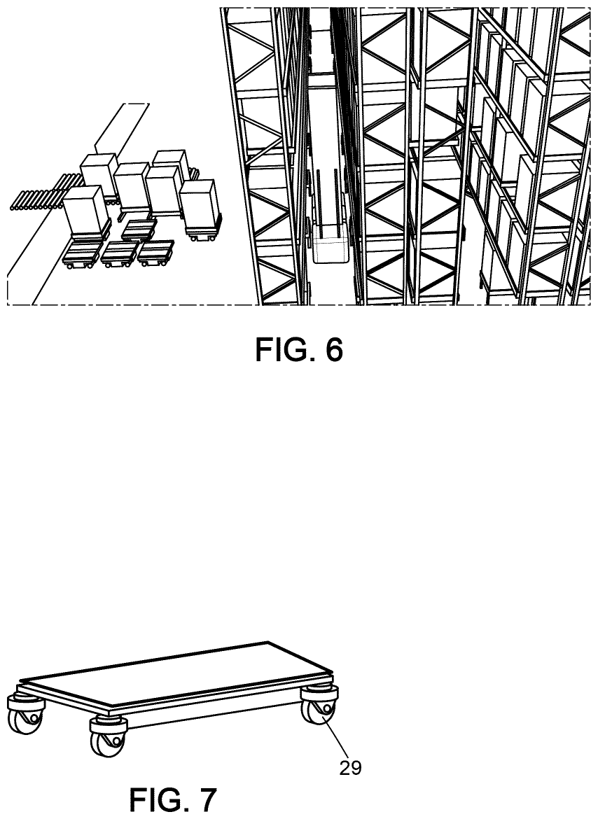

According to one embodiment, second vehicle V2 may comprise a lifting system comprising a platform PT, identified in FIG. 4, configured to move from a low position which allows positioning the second vehicle underneath a storage unit U resting on mechanical storage system SMT to a high position in which the platform lifts the storage unit and releases said storage unit U from mechanical storage system SMT.

According to another embodiment, when the transit location is without any mechanical storage system, second vehicle V2 may comprise an upper surface configured to support a storage unit and to allow transferring a storage unit between the transfer system of first vehicle V1 and the upper surface of the second vehicle. By way of illustration, the transfer system of first vehicle V1 may comprise a telescopic fork system, and the upper surface of second vehicle V2 may comprise grooves designed to receive the telescopic forks.

According to the present disclosure, the present facility further comprises at least one free passage PL under said storage racks, adjacent to said transit location ET and configured to allow said at least one second vehicle V2 to travel along a traffic lane Vc1; Vc2 that is transverse to aisles 3.

Free passage PL is understood to mean a passage under the rack, allowing the second vehicles to circulate on the horizontal surface and across the traffic lane, which is devoid of any mechanical storage system SMT or storage unit.

The traffic lane crossing free passage PL is not only configured for the circulation of second vehicles, but is devoid of any transit location for temporarily storing a storage unit under the rack, and is devoid of a storage unit.

Traffic lane Vc1; Vc2 and said at least one free passage PL are therefore without any mechanical storage system SMT for temporarily storing a storage unit which would require precise guidance to ensure insertion of the second vehicle between two mechanical interfaces of the temporary mechanical storage system.

Traffic lane Vc1; Vc2 allows second vehicles V2 carrying a storage unit U to circulate, without any interruption due to temporarily storing a storage unit, and without speed limitations due to inserting second vehicle V2 through a temporary mechanical storage system. The speed at which the second vehicles circulate may be greater than 1.5 m/s, or even greater than 2 m/s, even when the second vehicle crosses one of the storage racks by traveling on horizontal surface SH across free passage PL.

Free passage PL forms a section of traffic lane Vc1 (respectively Vc2) that traverses the rack, to allow the circulation of a line of second vehicles V2. The width of free passage PL extends so that is traverses the storage rack in transverse direction X, and at least in a dimension corresponding to the dimension of storage unit U in longitudinal direction Y. The height of free passage extends in vertical direction Z, from horizontal surface SH to at least the cumulative height of second vehicle V2 plus storage unit U carried by the second vehicle. In the case where the second vehicle comprises a lifting system, the height of the free passage extends in vertical direction Z, from horizontal surface SH to at least the cumulative height of second vehicle V2 plus storage unit U carried by the lifting system, in the raised position, of the second vehicle.

Traffic lane Vc1; Vc2 transverse to the aisles may extend into a portion of storage racks 2, or advantageously into all of storage racks 2. For this purpose, free passages PL are provided for all or part of storage racks 2, and are aligned in transverse direction X to form traffic lane Vc1, Vc2.

According to the present disclosure, the second vehicle is configured to transport a storage unit between said at least one transit location ET and said at least one location external to the storage racks, in particular by implementing:
at least one transverse movement of second vehicle V2 along traffic lane Vc1; Vc2, followed or preceded by
a longitudinal movement of second vehicle V2 between free passage PL and said at least one transit location ET, which is adjacent, below one of the storage racks, along a longitudinal movement direction of said storage rack.

In other words, second vehicle V2 is configured to change its movement direction between a movement direction transverse to said storage rack and a movement direction longitudinal to said storage rack, when second vehicle V2 is in a free passage PL.

When transit location ET comprises mechanical storage system SMT, said longitudinal movement of second vehicle V2 between free passage PL and said at least one transit location ET can ensure that second vehicle is in an insertion position under storage unit U supported by mechanical storage system SMT.

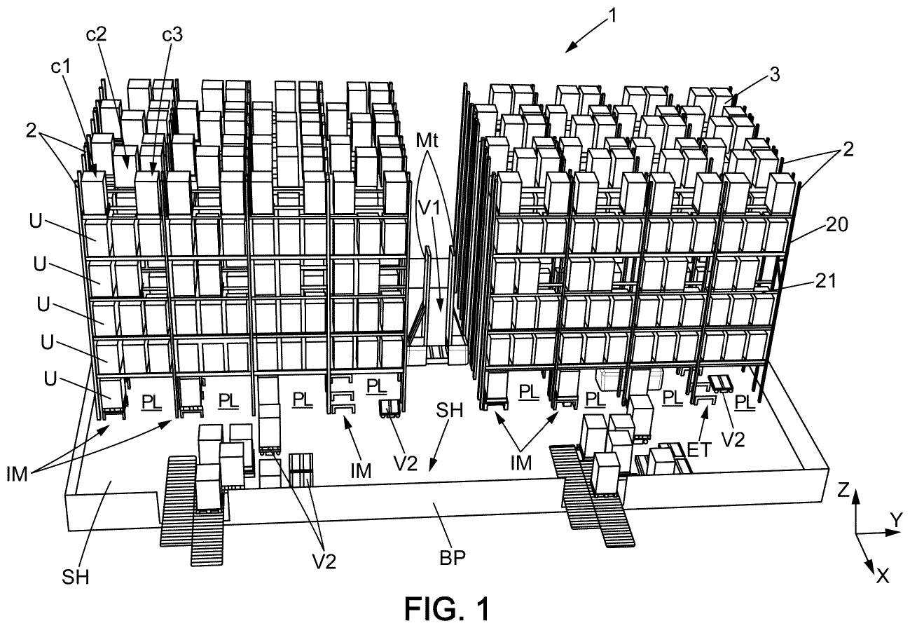

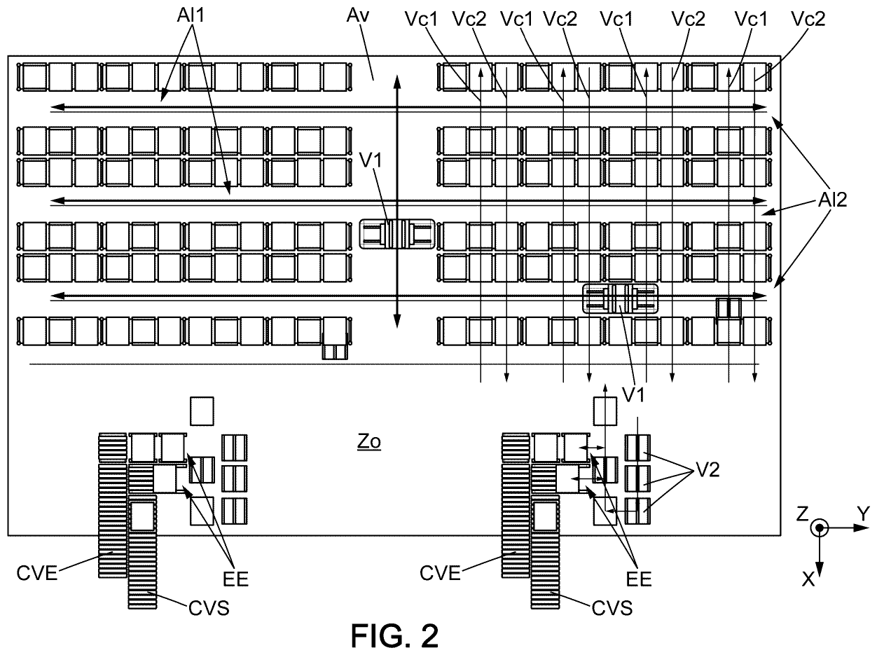

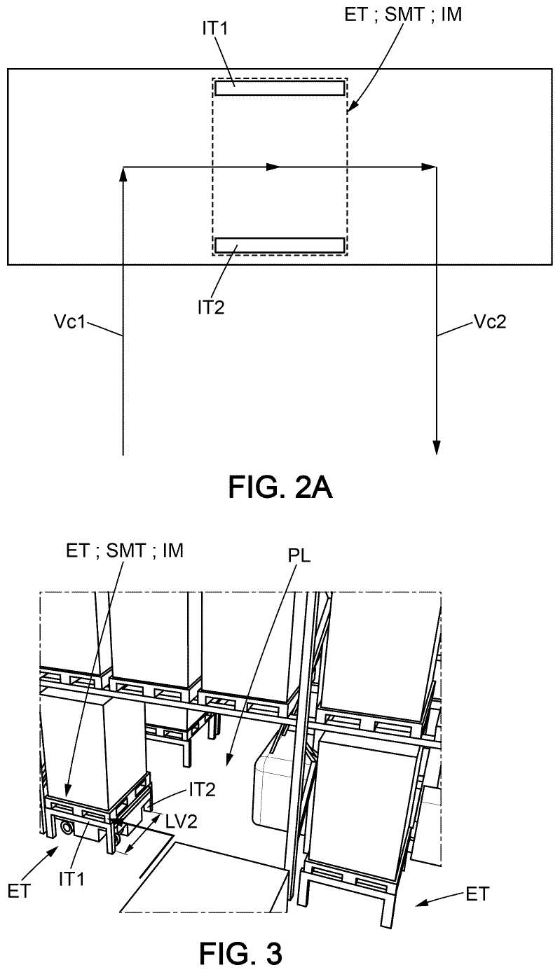

The angled arrow in FIG. 3 illustrates the path of a second vehicle V2 which moves transversely to the storage rack until reaching free passage PL, along the traffic lane that follows transverse direction X, then moves in longitudinal direction Y from free passage PL under storage rack 2 through mechanical storage system SMT, to be below storage unit U supported at transit location ET.

A change of direction of second vehicle V2 is made between the transverse movement in transverse direction X and the longitudinal direction Y, in particular without changing the orientation of the body of the vehicle.

The present disclosure also relates to a method for loading and retrieval that is implemented with a storage and retrieval facility 1 according to the present disclosure.

The method may have, for an operation /RT/ of retrieving a storage unit U from a storage location in one of the storage racks:
automated transfer operations to transfer storage unit U from the storage location in a storage rack to said at least one transit location ET under storage rack 2, via the or one of the first vehicles V1 then:
automated transfer operations to transfer storage unit U via the or one of the second vehicles V2, from said at least one transit location ET under the storage rack to at least one location external to the storage racks.

The automated transfer operations via the or one of the second vehicles V2 may be carried out by the or one of the second vehicles traveling at least in a longitudinal movement from said at least one transit location ET to the adjacent free passage, followed, after a change of direction of second vehicle V2, by the transverse movement of the second vehicle from free passage PL along a traffic lane Vc1, Vc2 in order to move to outside storage racks 2, to at least one location EE external to the storage racks.

The method may have, for an operation /CH/ of loading a storage unit into a storage location in the storage rack:
automated transfer operations to transfer storage unit U from said at least one location external to storage racks 2 to said transit location ET under one of the storage racks, via the or one of the second vehicles V2, then,
automated transfer operations to transfer storage unit U from said at least one transit location to the storage location in storage rack 2, via the or one of the first vehicles V1.

The automated transfer operations via the or one of the second vehicles may be carried out by longitudinal movement of the or one of the second vehicles V2 traveling along traffic lane Vc1; Vc2 to the free passage below the storage rack and adjacent to said at least one transit location ET, followed, after a change of direction of the second vehicle, by longitudinal movement from free passage PL to said adjacent transit location ET.

Generally, first vehicle 1 and second vehicle 2 are self-guided vehicles comprising an electronic wireless communication module and receiving guidance instructions from a central processing unit. Said central processing unit has one or more microprocessors, a memory, and instructions for constructing guidance instructions.

Said central processing unit may be remote and separate from the first and second vehicles.

The guidance instructions ensure the movement of first vehicles V1, in particular the movement along the aisles or from one aisle to another via an avenue, as well as the heightwise movement of transfer system ST along vertical direction Z, and the operation of transfer system ST for transferring storage unit U from a storage location and first vehicle V1.

The guidance instructions ensure the movement of second vehicles V2, in particular the transverse movement of the second vehicles along the traffic lane, followed or preceded by the longitudinal movement between free passage PL and the adjacent transit location ET, in the case of retrieval action /RT/ or loading operation /CH/.

In general, the number N_{ET} of transit locations ET along the length of a storage rack may be less than the number N_{U} of storage locations for each level in the rack along longitudinal direction Y, and therefore less than the number N_{U} of columns.

The number of free passages may correspond to the difference between the number N_{U} and the number of transit locations N_{ET}. Thus
N_{PL}=N_{U}−N_{ET}

Transit locations ET and free passages PL may be arranged in alternation along the length of storage rack 2 so that at least one free passage PL is associated as laterally adjacent to each transit location ET.

Preferably, all transit locations ET are accessible by at least one of second vehicles V2, by the longitudinal movement between free passage PL and transit location ET.

According to one advantageous embodiment, all or part of free passages PL are dual passages, adjacent to a same transit location ET, the dual passages allowing two second vehicles V2 to circulate, each possibly carrying a storage unit U along a respective first traffic lane Vc1 and second traffic lane Vc2 which are independent, in opposite directions transversely to the storage rack, the two second vehicles V2 able to pass each other across free passages PL that are adjacent to a same transit location.

Having two traffic lanes, first traffic lane Vc1 and second traffic lane Vc2, makes it possible to assign opposite directions of circulation to the two respective traffic lanes, thus reducing the risk of traffic jams and immobilization of second vehicles.

The presence of the dual free passages makes it possible to implement a method for loading and retrieval in which free passages PL adjacent to said transit location are dual passages, comprising for the or for each transit location:
first free passages PL of different storage racks forming first traffic lane Vc1 for second vehicles V2,
second free passages PL of said different storage racks, forming second traffic lane Vc2 for second vehicles V2.

Advantageously, the method may provide that second vehicles V2 travel only in a first direction along first traffic lane Vc1, and second vehicles V2 travel only in a second direction that is opposite to the first direction, along second traffic lane Vc2. As the lanes are independent, the circulation of second vehicles Vc2 along first traffic lane Vc1 does not interfere with the circulation of second vehicles V2 along second traffic lane Vc2.

Generally speaking, the width of first traffic lane Vc1 along longitudinal direction X of the storage rack and the width of second traffic lane Vc2 may each correspond to the width of a storage location.

Generally speaking, said at least one location external to the storage racks, also called the external location EE, may be in a zone Zo facing the storage racks, on one side of the storage racks in transverse direction Y, and as illustrated in FIGS. 1 and 2. The transit location(s) are accessible for second vehicles possibly loaded with storage units, by taking one of the traffic lanes adjacent to the transit location ET to be served.

Second vehicles V2 may travel from zone Zo, outside storage racks 2, to said transit location, by traveling in first traffic lane Vc1 while traveling in a transverse movement along the first direction, then changing direction and accessing transit location ET by a longitudinal movement from first traffic lane Vc1 to transit location ET, in particular with a view to transporting a storage unit during loading /CH/, or with a view to receiving a storage unit during retrieval /RT/.

Subsequent to parking at transit location ET, in particular subsequent to transferring storage unit U to mechanical storage system SMT, or subsequent to transferring storage unit U to first vehicle during loading /CH/, second vehicle V2 may move to second traffic lane Vc2 in a longitudinal movement, then change direction and return to zone Zo by a transverse movement along second traffic lane Vc2 in the second direction.

First traffic lane Vc1 and second traffic lane Vc2 may advantageously serve the different transit locations ET belonging to the different storage racks arranged in parallel and adjacent, by an ordered circulation of the second vehicles which travel in the first direction in first traffic lane Vc1 and in the second direction in second traffic lane Vc2. The one-way directions of the traffic in the first lane and second lane may be reversed.

According to a first variant, first traffic lane Vc1 and second traffic lane Vc2 are arranged adjacent to a same transit location ET to be served, on the same side of transit location ET, and as illustrated in FIG. 1 or 2, which requires crossing first traffic lane Vc1 during the longitudinal movement from second lane Vc2 to transit location ET.

According to a second variant, first traffic lane Vc1 and second traffic lane Vc2 may be arranged one on either side of transit location ET to be served. As illustrated in FIG. 2A, second vehicle V2 may access transit location ET via first traffic lane Vc1, in particular from zone Zo, be parked at said transit location in particular for retrieval or loading operations, then can leave the transit location via second traffic lane Vc2 without having to cross first lane Vc1, unlike the first variant.

According to one embodiment, illustrated in FIG. 1, mechanical storage system SMT comprises a pair of mechanical interfaces IM comprising a first mechanical interface IT1 and a second mechanical interface IT2 which are parallel to each other, each oriented longitudinally along the length of storage rack 2, namely in longitudinal direction Y.

Generally speaking, mechanical storage system SMT, in particular the pairs of interfaces, may form obstacles to the movement of second vehicles, transversely to the storage rack.

In the parking position at transit location ET, second vehicle V2 is arranged between first interface IT1 and second interface IT2 in the insertion position.

Generally, second vehicle V2 may comprise a lifting system comprising a platform PT, identified in FIG. 4, configured to move from a low position which allows the second vehicle to be positioned below a storage unit U resting on mechanical storage system SMT, to a high position in which the platform lifts the storage unit and disengages storage unit U from mechanical storage system SMT.

Generally, storage units U may each have a width dimension, and a length dimension that is greater than the width dimension.

Storage units U are stored longitudinally in the storage locations, extending in a depth dimension of storage rack 2 that is transverse to storage rack 2, meaning that storage units U are oriented longitudinally along transverse direction Y.

First vehicle V1 may then be configured to transport one of storage units U from a storage location located at a height to said transit location, without changing the orientation of storage unit U: positioning storage unit U at transit location ET, in particular on mechanical storage system SMT, oriented longitudinally along the transverse direction of storage rack 2.

When mechanical storage system SMT has the pair of mechanical interfaces comprising first mechanical interface IT1 and second mechanical interface IT2, storage unit U may be oriented longitudinally, along the transverse direction, while resting on first interface IT1 and on second interface IT2.

Second vehicle(s) V2 may comprise a length dimension LV2 that is less than or equal to the depth dimension of storage rack 2, and a width dimension, less than the length of second vehicle V2, that is less than the longitudinal dimension of a storage location.

First mechanical interface IT1 and second mechanical interface IT2 may be spaced apart, in the direction transverse to the storage rack, by a distance that is greater than length dimension LV2 of a second vehicle V2.

Second vehicle V2 may be configured to change direction without changing the orientation of the storage unit that it transports.

Second vehicle V2 may have a fixed orientation during movements of the second vehicle, always being oriented longitudinally in transverse direction X, in particular during transverse movement in the traffic lane, in particular first traffic lane Vc1 or second traffic lane Vc2, and also during longitudinal movement between free passage PL and transit location ET due to the system for changing direction SDV2 which is configured to change the direction of advancement of the second vehicle without changing the orientation of the vehicle body.

Alternatively, second vehicle V2 may be configured to change direction by rotating about a vertical axis, without substantially advancing. For example, the second vehicle may comprise a rotation mechanism which allows the wheels on one side of the vehicle to rotate at a speed and/or in a direction that is different from those on the other side.

According to one embodiment, storage units U may be palletized contents, each comprising a pallet. The pallets may be in the 1200 by 1000 format (length and width in millimeters), for example an ISO pallet, or any other pallet format known to those skilled in the art such as 1200 by 800 for a Euro pallet format. The products on the pallet may be packaged directly under a wrapping of plastic film to ensure they are held on the pallet, or may be contained in packaging, typically cardboard boxes, held on the pallet by wrapped plastic film.

According to one variant, storage units U may be receiving pallets comprising already palletized content. Thus, even if customers use different types of pallets, these can be placed on receiving pallets for storage in the facility.

These receiving pallets may be in the 1200 by 1000 format and be open pallets, i.e. the sides of the pallet are open, forming an entry that facilitates insertion of the forks. These receiving pallets facilitate the loading and unloading of palletized contents at the input and output conveyors described below.

In general, and in particular when the storage units are palletized contents, a peripheral barrier BP may form a limited-access enclosure containing storage racks 2, as well as first vehicles V1 and second vehicles V2 circulating on horizontal surface SH, at the storage racks or externally to the storage racks. In particular, the enclosure also encloses zone Zo facing the storage racks, including external locations EE.

According to such an embodiment, the peripheral barrier prevents access into the enclosure by operators.

Said facility may comprise:
an input conveyor CVE for storage units, for the entry of storage units into said at least one location external to the storage rack, said units intended to be transported by second vehicles V2 to said at least one transit location ET in preparation for loading them into the storage locations of the rack,
an output conveyor CVS for storage units, for the exit of storage units removed from storage locations of storage rack 2, conveyed by second vehicles V2 from said at least one transit location ET to said at least one location external to the storage racks.

According to one embodiment, when said facility comprises a peripheral barrier, input conveyor CVE and output conveyor CVS each pass through the peripheral barrier.

The input and output conveyor may comprise a system of forks that are vertically moveable between a low position at the level of the upper surface or platform of the second vehicle and a high position at a conveying system.

Alternatively, the input and output conveyor may comprise a conveying system, its end comprising an interface for receiving palletized content.

According to one embodiment (not illustrated), said storage and retrieval facility may be an order preparation facility, said storage units comprising containers, such as bins, containing products.

Such an order preparation facility comprises one or more manual or robotic order preparation stations.

During a retrieval /RT/, a storage unit may be transported by the first vehicle to said transit location, then by the second vehicle from said transit location to said external location at the order preparation station, to allow collection operations by an operator or by a robotic arm.

The products collected in one or more storage units U are transferred into an order box. Once the collection operations have been carried out, storage unit U may be returned by a loading operation /CH/ via second vehicle V2 to transit location ET, then via first vehicle V1 from transit location ET to a storage location in one of the storage racks.

In general, and according to a first aspect of the method for storage and retrieval in which said transit location is provided with a mechanical storage system:
during retrieval according to /RT/, said at least one first vehicle V1 transfers storage unit U from the storage location in the storage rack to said at least one transit location ET under the storage rack, depositing the storage unit on mechanical storage system SMT at a distance from the horizontal surface,
during loading according to /CH/, the storage unit has been stored in transit location ET at a distance from horizontal surface SH by mechanical storage system SMT, when said at least one first vehicle V1 transfers the storage unit from said transit location.

Said method may comprise, for the retrieval of a storage unit located in a storage location in one of the storage racks, in accordance with /RT/:
/A1/ moving the or one of the first vehicles V1 along one of aisles 3, in line with a column comprising storage unit U, and moving transfer system ST vertically along the mast to the height of the storage location of said storage unit,
/B1/ transferring storage unit U from the storage location to first vehicle V1, in particular by deploying then retracting the telescopic arm,
/C1/ lowering transfer system ST carrying the storage unit and depositing said storage unit on said at least one mechanical storage system SMT under the storage rack, in particular by deploying the telescopic arm,
/D1/ moving one of second vehicles V2 to the storage racks,
/E1/ moving second vehicle V2 at least transversely to the storage rack, along the traffic lane, in particular along first traffic lane Vc1, to one of free passages PL that is adjacent to mechanical storage system SMT supporting storage unit U, second vehicle V2 being arranged under storage rack 2,
/F1/ changing the direction of movement of vehicle V2 and moving second vehicle V2 longitudinally to the storage rack until the second vehicle is inserted under storage unit U which rests on mechanical storage system SMT, with platform PT in the low position,
/G1/ raising platform PT to its high position until said storage unit is lifted relative to mechanical storage system SMT,
/H1/ jointly moving second vehicle V2 and storage unit U carried on platform PT, longitudinally to the storage rack, to free passage PL under the storage rack,
/I1/ changing the direction of movement of second vehicle V2 and jointly moving second vehicle V2 and storage unit U carried on the platform, transversely to storage rack 2 along the traffic lane, in particular in second traffic lane Vc2, outside storage racks 2.

In general, said method may comprise, for loading a storage unit into a storage location in one of the storage racks in accordance with /CH/:
/A2/ moving a second vehicle V2 carrying a storage unit U on its platform PT, to storage racks 2,
/B2/ moving second vehicle V2 at least transversely to the storage rack, along the traffic lane, in particular the first traffic lane, to one of free passages PL that is adjacent to a mechanical storage system SMT without any storage unit,
/C2/ changing the direction of movement of second vehicle V2 and moving the vehicle longitudinally to the storage rack until second vehicle V2 is inserted through mechanical storage system SMT, the platform being in the high position and supporting said storage unit,
/D2/ lowering platform PT to the low position and placing storage unit U on mechanical storage system SMT,
/E2/ moving one of first vehicles V1 along an aisle 3, and moving transfer system ST vertically along the mast to the height of said storage unit supported on mechanical storage system SMT,
/F2/ transferring storage unit U supported on mechanical storage system SMT, to first vehicle V1, in particular by deploying then retracting the telescopic arm,
/G2/ raising transfer system ST carrying storage unit U, and placing said storage unit in one of the storage locations in storage rack V2 via the transfer system, in particular by deploying the telescopic arm.

Generally, a control unit, in particular said central processing unit, may comprise one or more microprocessors, a memory, and a set of instructions configured for co-operating with the microprocessor(s) in order to implement:
actions /A1/, /B1/, /C1/, /D1/, /E1/, /F1/, /G1/, /H1/, /I1/ in accordance with a retrieval /RT/, and
actions /A2/, /B2/, /C2/, /D2/, /E2/, /F2/, /G2/ in accordance with a loading /CH/.

Advantageously, at the end of step /D2/ of loading /CH/, when second vehicle V2 is in a position for insertion through mechanical storage system SMT and with its platform in the low position, second vehicle V2 remains parked at this location, waiting for another storage unit to be deposited on said mechanical storage system in accordance with step /C1/ of retrieval /RT/. This makes it possible to optimize the movements of second vehicle V2.

In general, and in accordance with the method for storage and retrieval according to a second aspect in which said transit location is without any mechanical storage system:
during a retrieval in accordance with /RT/, said at least one first vehicle V1 transfers storage unit U from the storage location in the storage rack to said at least one transit location ET under the storage rack, depositing the storage unit on second vehicle V2 parked at said at least one transit location ET;
during a loading in accordance with /CH/, said at least one second vehicle V2 carrying the storage unit is parked at said at least one transit location ET, when first vehicle V1 transfers the storage unit from said transit location (ET) to said storage location.

In particular, said method may comprise, for the retrieval of a storage unit at a storage location in one of the storage racks in accordance with /RT/:
/A3/ moving the or one of the first vehicles V1 along one of aisles 3, in line with a column comprising storage unit U, and moving transfer system ST vertically along the mast up to the height of the storage location of said storage unit,
/B3/ transferring storage unit U from the storage location to first vehicle V1, in particular by deploying then retracting the telescopic arm,
/C3/ lowering transfer system ST carrying the storage unit and depositing said storage unit on at least one second vehicle V2 parked at said at least one transit location ET, in particular by deploying then retracting the telescopic arm,
/D3/ jointly moving second vehicle V2 and storage unit U being carried on the vehicle, longitudinally to the rack all the way to free passage PL under the storage rack, which is adjacent to transit location ET,
/E3/ changing the direction of movement of second vehicle V2 and jointly moving the second vehicle and storage unit U carried on board the vehicle, transversely to storage rack 2 and along the traffic lane outside storage racks 2.

In particular, said method may comprise, for loading a storage unit into a storage location in one of the storage racks in accordance with /CH/:
/A4/ moving a second vehicle V2 carrying a storage unit U, to the storage racks,
/B4/ moving second vehicle V2 at least transversely to the storage rack, along the traffic lane, in particular first traffic lane Vc1, to one of free passages PL which is adjacent to transit location ET having no storage unit,
/C4/ changing the direction of movement of second vehicle V2 and moving second vehicle V2 longitudinally to the storage rack, until second vehicle V2 carrying the storage unit is parked at said transit location ET,
/D4/ moving one of first vehicles V1 along an aisle, and moving transfer system ST vertically along the mast to the height of said storage unit being supported by second vehicle V2 parked at transit location ET,
/E4/ transferring storage unit U being supported by second vehicle V2, to first vehicle V1, in particular via transfer system ST, by deploying then retracting the telescopic arm,
/F4/ raising the transfer system carrying the storage unit and placing said storage unit in one of the storage locations in storage rack 2, in particular by deploying then retracting the telescopic arm.

In general, a control unit, in particular said central processing unit, may comprise one or more microprocessors, a memory, and a set of instructions configured for co-operating with the microprocessor(s) in order to implement:
actions /A3/, /B3/, /C3/, /D3/ /E3/ in accordance with a retrieval /RT/,
actions /A4/, /B4/, /C4/, /D4/ /E4/ /F4/ in accordance with a loading /CH/.

Advantageously, at the end of step /E4/ in a loading /CH/, when storage unit U has been unloaded from a second vehicle V2, this second vehicle remains parked at transit location ET, waiting for another storage unit in accordance with step /C3/ in a retrieval /RT/. This makes it possible to optimize the movements of second vehicle V2.

### LIST OF REFERENCE SYMBOLS

1. Storage and retrieval facility
2. Storage racks
20. Uprights
21. Cross-members
3. Aisles between storage racks
30. Belt
Al1. First aisles
Al2. Second aisles
Av. Avenue
BP. Peripheral barrier
c1, c2, c3. Columns distributed along the length of the storage rack (in particular first, second and third).
EE. External location (outside the storage racks)
ET. Transit location,
IM—Pair of mechanical interfaces,
IT1, IT2. First and second mechanical interfaces.
LV2. Length dimension of the second vehicles.
MO. Engine
Mt. Mast of first vehicles
Mt1, Mt2. First and second mast
Pl. Pulleys
PL. Free passages
PR. Retracted position (of the transfer system of first vehicles)
PT. Platform of the second vehicle
SDV2. System for changing direction of the second vehicle
SEV2. Horizontal drive system of the second vehicle
SG1, SG2, SG3. Respectively the first segment, second segment, and third segment (telescopic arm of the transfer system),
SH. Horizontal surface
SMT. Mechanical storage system (under racks)
ST. Telescopic system of first vehicles
U. Storage units
V1. First automated guided vehicles
V2. Second automated guided vehicles
Vc. Traffic lanes
Vc1. First traffic lane
Vc2. Second traffic lane
Zo. Zone facing the storage rack, where second vehicles circulate.

1. A storage and retrieval facility for storage units, comprising:
a plurality of storage racks, spaced apart from each other to form aisles, each storage rack comprising a plurality of superimposed storage locations for supporting storage units at a height relative to a horizontal surface such as the floor,
at least one transit location arranged under at least one of the storage racks, for temporarily receiving a storage unit,
at least one first vehicle configured to circulate in the aisles and to transport a storage unit between a storage location located at a height and said at least one transit location,
at least one second vehicle configured to transport a storage unit between said at least one transit location and at least one location external to the storage racks,
at least one free passage under said storage racks, adjacent to said transit location, configured to allow said at least one second vehicle to travel along a traffic lane that is transverse to the aisles.

2. The storage and retrieval facility for storage units according to claim 1, wherein the first vehicle is configured to transport said storage unit between said storage location located at a height, to resting on an upper surface of at least one second vehicle parked at the transit location.

3. The storage and retrieval facility for storage units according to claim 1, wherein said transit location comprises a mechanical storage system configured for temporarily supporting a storage unit at a distance from the horizontal surface, and wherein a longitudinal movement of the second vehicle from the free passage to said adjacent transit location ensures that the second vehicle is in an insertion position under said storage unit supported by the mechanical storage system.

4. The storage and retrieval facility for storage units according to claim 3, wherein said mechanical storage system comprises a pair of mechanical interfaces comprising a first mechanical interface and a second mechanical interface which are parallel to each other, each oriented longitudinally along the length of the storage rack, and wherein said second vehicle is arranged between the first interface and the second interface, in the insertion position.

5. The storage and retrieval facility for storage units according to claim 3, wherein the second vehicle comprises a lifting system comprising a platform configured to move from a low position which allows positioning the second vehicle below a storage unit resting on the mechanical storage system, to a high position where the platform raises the storage unit and disengages said storage unit from the mechanical storage system.

6. The storage and retrieval facility for storage units according to claim 1, comprising storage units which each have a width dimension, and a length dimension that is greater than the width dimension, and wherein
the storage units are stored longitudinally in the storage locations, along a depth dimension of the storage rack that is transverse to the storage rack, and
the first vehicle is configured to transport one of the storage units from a storage location located at a height to a transit location, without changing the orientation of said storage unit, by positioning said storage unit at the transit location, oriented longitudinally along the transverse direction of the storage rack.

7. The storage and retrieval facility for storage units according to claim 1, wherein the or each storage rack comprises several columns distributed along the lengthwise direction of the storage rack, each column comprising a plurality of superimposed storage locations for respectively receiving a plurality of storage units, and wherein the or each second vehicle comprises a length dimension that is less than or equal to the depth dimension of the storage rack, and a width dimension that is less than the length of the second vehicle, less than the longitudinal dimension of a storage location.

8. The storage and retrieval facility for storage units according to claim 4, wherein the first mechanical interface and the second mechanical interface are spaced apart, in the direction transverse to the storage rack, by a distance that is greater than the length dimension of a second vehicle.

9. The storage and retrieval facility according to claim 1, wherein all or part of the free passages are dual passages which are adjacent to a same transit location, the dual passages enabling two second vehicles, each possibly carrying a storage unit, to travel along a respective first traffic lane and second traffic lane which are independent, in opposite directions and transverse to the storage rack, the two second vehicles being able to pass by each other through the free passages that are adjacent to a same transit location.

10. The storage and retrieval facility according to claim 1, wherein the second vehicle is configured to transport a storage unit between said at least one transit location and said at least one location external to the storage racks, by implementing:
at least one transverse movement of the second vehicle along the traffic lane, followed or preceded by
a longitudinal movement of the second vehicle between the free passage and said at least one adjacent transit location, below one of the storage racks, in a movement direction that is longitudinal to said storage rack.

11. The storage and retrieval facility according to claim 1, wherein the or each second vehicle comprises a horizontal drive system configured to ensure movement on the horizontal surface and to move the second vehicle selectively in a first direction parallel to the longitudinal direction of the storage racks, or in a direction transverse to the longitudinal direction of the rack, as well as a system for changing direction from the first direction to the second direction or vice versa, without changing the orientation of the vehicle.

12. The storage and retrieval facility according to claim 1, wherein the first vehicle(s) comprise, in whole or in part:
a horizontal drive system configured to move the vehicle on the horizontal surface,
at least one mast, and
a transfer system which is movable vertically along the mast, configured to transfer a storage unit between the first vehicle and one of the storage locations.

13. The storage and retrieval facility according to claim 1, comprising storage units, and wherein the storage units are palletized contents, each comprising a pallet.

14. The storage and retrieval facility according claim 1, wherein a peripheral barrier (BP) forms an enclosure with limited access, containing the storage racks as well as the first vehicles and second vehicles circulating on the horizontal surface.

15. The storage and retrieval facility according to claim 14, comprising:
an input conveyor for storage units, crossing the peripheral barrier in order to bring storage units to said at least one location external to the storage rack, said units being intended to be transported by the second vehicles to said at least one transit location, and for the purposes of loading them into storage locations in the rack,
an output conveyor for storage units, crossing the peripheral barrier in order to bring out storage units that have been retrieved from storage locations in the storage rack and conveyed by the second vehicles from said at least one transit location to said at least one location external to the storage racks.

16. A method for loading and retrieval which makes use of a storage and retrieval facility according to claim 1, wherein:
/RT/ a retrieval of a storage unit from a storage location in one of the storage racks is carried out by:
automated transfer operations which transfer the storage unit from the storage location in the storage rack to said at least one transit location under the storage rack, via the or one of the first vehicles, then by:
automated transfer operations which transfer the storage unit via the or one of the second vehicles from said at least one transit location to at least one location external to the storage racks,
and/or
/CH/ a loading of a storage unit into a storage location in the storage rack is carried out by:
automated transfer operations which transfer the storage unit from said at least one location external to the storage racks, to said transit location under one of the storage racks, via the or one of the second vehicles V2, then by:
automated transfer operations which transfer the storage unit from said at least one transit location to the storage location in said storage rack, via the or one of the first vehicles.

17. The method for loading and retrieval according to claim 16, wherein:
during a retrieval according to /RT/, said at least one first vehicle transfers the storage unit from the storage location in the storage rack to said at least one transit location under the storage rack, by depositing the storage unit on the second vehicle parked at said at least one transit location;
during a loading according to /CH/, said at least one second vehicle carrying the storage unit is parked at said at least one transit location, when said first vehicle transfers the storage unit from said transit location to said storage location.

18. The method for loading and retrieval according to claim 16, wherein:
during a retrieval according to /RT/, said at least one first vehicle transfers the storage unit from the storage location in the storage rack to said at least one transit location under the storage rack, by depositing the storage unit on the mechanical storage system, at a distance from the horizontal surface,
during a loading according to /CH/, the storage unit has been stored at the transit location at a distance from the horizontal surface via the mechanical storage system, when said at least one first vehicle transfers the storage unit from said transit location.

19. The method for loading and retrieval according to claim 16, wherein:
during a retrieval according to /RT/, the automated transfer operations via the or one of the second vehicles are carried out by the or one of the second vehicles traveling at least in said longitudinal movement from said at least one transit location to the adjacent free passage, followed, after a change in direction of the second vehicle, by a transverse movement of the second vehicle through the free passage along the traffic lane in order to exit the storage racks to at least one location external to the storage racks.
during a loading according to /CH/, the automated transfer operations via the or one of the second vehicles are carried out by the or one of the second vehicles traveling along the traffic lane to the free passage below the storage rack and adjacent to said at least one transit location, followed, after a change in direction of the second vehicle, by a longitudinal movement from the free passage to said adjacent transit location.

20. A storage and retrieval facility according to claim 1, further comprising a control unit, in particular a central processing unit, comprising one or more microprocessors, a memory, and a set of instructions configured for co-operating with the microprocessor(s) in order to implement the method for loading and retrieval according to claim 16.
